(19) United States
(12) Patent Application Publication
(10) Pub. No.: US 2026/0320039 A1
(43) Pub. Date: Oct. 15, 2026

(54) MACHINE LEARNING FRAMEWORK FOR AUTOMATED REQUEST PROCESSING TASKS

(71) Applicant: Optum, Inc., Minnetonka, MN (US)

(72) Inventors: Carlos Winsor Morato, Sammamish, WA (US); Zhili Yang, Chesterbrook, PA (US); Zahra Rajabi, Vienna, VA (US)

(21) Appl. No.: 19/175,669

(22) Filed: Apr. 10, 2025

(51) Int. Cl. G06F 16/2452; G06F 16/2455; G06F 40/295; G06N 20/20

(52) U.S. Cl. CPC G06F 16/24522; G06F 16/2455; G06F 40/295; G06N 20/20

(57) ABSTRACT

Various embodiments of the present disclosure provide machine learning framework for automated request processing tasks that improves the functionality of a computer in various aspects. The techniques comprise generating, by a first machine learning model, a target feature based on a text unit within a message; determining a structured query set based on an entity code associated with the target feature; generating, using a second machine learning model, a prompt for a structured query of the structured query set based on a query record set that comprises a collection of data records associated with an individual; generating, by the second machine learning model based on the prompt, a predicted response to the structured query; and generating, by a third machine learning model based on the predicted response and the structured query set, a predicted output for the message that comprises a message response and an explainable text segment.

### BACKGROUND

Various embodiments of the present disclosure address technical challenges related to computer interpretation of text-based data, such as those used in automated computed operations processes. In many domains, computers are tasked with analyzing and interpreting natural language text to generate appropriate responses for a request processing task. Traditional techniques for doing so are hindered by several technical challenges with text recognition and interpretation, comprising accurately identifying task-specific entities within natural language text that may comprise anomalies, such as misspellings, ambiguous language, and other nuances that obfuscate the semantic meaning of text from traditional text processing techniques. For example, traditional rule-based and/or machine learning text processing techniques may be configured or trained to identify predefined or learned entities from text; however, the performance (e.g., accuracy, precision, recall) of these approaches falls when such entities are modified (e.g., misspellings) or replaced (e.g., with synonyms or ambiguous language) with anomalies common in real world use cases. This leads to performance drops between a training and/or evaluation environment and the real world, which limits the reliability of traditional request processing systems that rely on such techniques. These reliability challenges with traditional request processing systems prevent the use of automated machine learning frameworks in complex use cases due to the black box nature of traditional computer-based processing models—that provide outputs without clear explanations of the system's output generation process. This lack of transparency may limit the usefulness and trustworthiness of automated responses to a request processing task in many applications.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram showing example data structures and components for machine learning framework for request processing tasks in accordance with some embodiments of the present disclosure.

FIG. 5 depicts an operational example of a machine learning text enrichment pipeline for generating a target feature in accordance with some embodiments of the present disclosure.

FIG. 6 depicts an operational example of a framework for generating synthetic message training dataset for training a named entity recognition model in accordance with some embodiments of the present disclosure.

FIG. 7 depicts an operational example of a machine learning guideline alignment pipeline for generating a query response in accordance with some embodiments of the present disclosure.

FIG. 8 depicts an operational example of a knowledge fusion retrieval augmented generation framework in accordance with some embodiments of the present disclosure.

FIG. 9 depicts an operational example of a code generation pipeline in accordance with some embodiments of the present disclosure.

FIG. 10 depicts an operational example of a prediction pipeline in accordance with some embodiments of the present disclosure.

FIG. 11 depicts a flowchart diagram of an example process for machine learning framework for request processing tasks in accordance with some embodiments of the present disclosure.

### DETAILED DESCRIPTION

Various embodiments of the present disclosure provide a machine learning framework that leverages an interpretable machine learning code and guidance generation pipeline to improve the functionality of a computer with respect to computer interpretation and processing tasks such as request processing tasks. To do so, some embodiments of the present disclosure provide a machine learning framework that synthesizes a series of machine learning model predictions with rule-based logic to process text (e.g., message that comprises natural language text reflective of a request processing task) that is prone to irregularities. To overcome performance deficiencies of traditional text recognition systems with respect to irregular text, the series of machine learning model predictions comprise a first stage prediction that classifies a textual entity within the text using a first set of transformer-based named entity recognition models that is trained to recognize a set of predefined textual entities from anomalous counterparts, such as variations in how an entity is notated or identified between different organizations and/or individuals, misspelled variations, synonyms, ambiguous related terms or phrases, and/or the like. For example, this first set of models may comprise a named entity recognition model that may detect a portion of text that is likely to be a named entity (e.g., via a confidence score determined by the model for the portion of text that meets or exceeds a threshold confidence threshold) and may encode the text portion using an encoder model to generate an embedding. In some examples, a known entity is predicted to be associated with the detected entity (e.g., the text portion) based at least in part on determining a nearest pre-generated embedding to the embedding generated for the text portion. This pre-generated embedding may have been previously generated by the encoder model using a known entity name and stored in a database.

By recognizing a textual entity from a set of predefined textual entities, a first stage prediction may enable the selection of predefined rules-based logic, such a decision tree representative of a structured query set, that facilitates retrieval of relevant information that informs the output of a machine learning framework such as machine learning framework for a request processing task. This, in turn, enables an improved second stage prediction that comprises a response and explanatory metadata for the output (e.g., response) of the machine learning framework in line with the predefined rules-based logic. In this way, the machine learning framework may expand computer-based tasks to complex tasks that may be initiated from text.

More particularly, the machine learning framework of the present disclosure provides performance improvements (e.g., in terms accuracy and explainability) to traditional frameworks for request processing that are resource intensive, prone to error, and lack explainability. To do so, the machine learning framework combines a set of specialized machine learning models with complementary rule-based logic in a divide a conquer approach to request processing that integrates the advantages of both machine learning and rule-based approaches into a cohesive framework.

The machine learning framework, for example, may comprise a first machine learning model that is specially trained for extracting entities from text that correspond to one of a set of predefined rules-based logics. The first machine learning model may be trained over a set of training operations to convert a domain-specific transformer (e.g., trained for a particular domain with multiple sub-tasks) to a task-specific transformer (e.g., finetuned for a specific task within a particular domain) capable of detecting entities from any one of a combination of text anomalies (e.g., entity identification variation, misspellings, ambiguous language) that traditionally hinder the performance of other text interpretation techniques. In this way, a first machine learning model of the machine learning framework may improve the accuracy of downstream processes of the machine learning framework by accurately detecting an entity from input text that may be used to process the input text according to a specific rules-based logic.

In addition, or alternatively, the machine learning framework may comprise rules-based logic and a second machine learning model configured to adapt the rules-based logic to computer-executable code of a particular syntax. By doing so, the rule-based logic associated with a detected entity may be translated to a computer-executable form to improve processing times of the machine learning framework. In some examples, the computer-executable code may be configured to output both a response and explainable metadata that may be mapped back to the rules-based logic to improve the explainability of the machine learning framework. In this manner, the machine learning framework may combine the interpretability of rules-based logic with the improved processing speeds of computer-executable code to improve both the speed and explainability of the system. In some examples, the machine learning framework may comprise a third machine learning model that is specially configured to convert the outputs of the computer-executable code to a user interpretable summary to further improve the interpretability of the computer operations.

In this manner and as described in further detail herein, the machine learning framework of the present disclosure (i) accurately and effectively understand natural language text reflective of a request processing task; (ii) resolves discrepancies between detected entities in natural language text and the feature (e.g., known entities) they represent in a domain-specific ontology; (iii) enhances the accuracy of text search, reasoning, and comprehension by computers and machine learning models; (iv) enables identification and retrieval of relevant data that guides and informs the output of the machine learning framework by transforming natural language text to a recognizable and standardized target feature within the domain; and (v) enables adaptation to dynamic guidelines in a domain (e.g., when new, modified, or altered guidelines are introduced in a domain) by generating and using a computer-executable code to generate predicted output; and (vi) enables generation of a prediction output that comprises an explainable text segment that provides clear explanations of the system's output generation process and computer-executable processes and/or code.

Examples of technologically advantageous embodiments of the present disclosure comprise improved: (i) robust and enhanced request processing techniques, (ii) machine learning model pipelines, (ii) entity recognition within a natural language text in a domain, (iv) improved entity matching to domain-specific ontology, (v) improved text search, reasoning and comprehension, (vi) information retrieval, and (vii) adaptation to dynamic guidelines within a domain, among other aspect of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that a block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

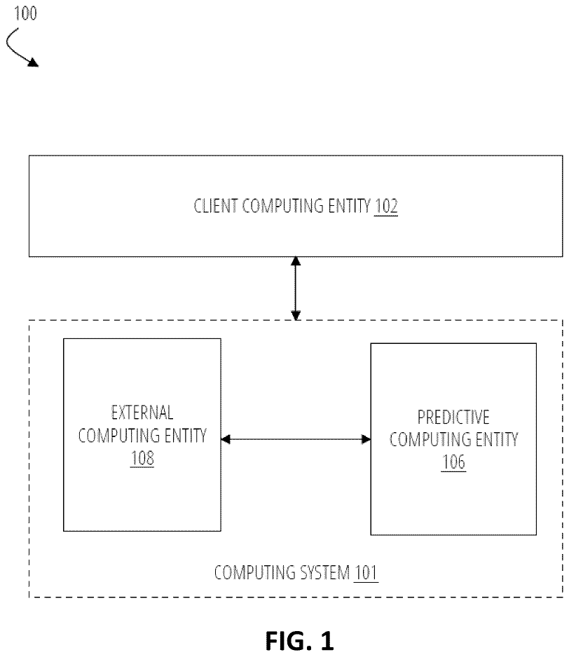

FIG. 1 depicts an example overview of an architecture 100 in accordance with some embodiments of the present disclosure. The architecture 100 comprises a computing system 101 configured to receive a request from client computing entities 102, process the request to generate an output, and provide the output to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate query response outputs, message response outputs, and/or other machine learned outputs. The models may be adapted to an automated machine learning framework comprising a text enrichment component, a guideline alignment component, and a prediction engine component that may collectively process a request using a machine learning model pipeline. Some techniques of the present disclosure may adapt traditional models of a cohesive framework, such as the automated machine learning framework, for more efficiently handling portions of the automated request processing tasks.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate an output, and provide the output to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, a storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., machine learning techniques for generating interpretable machine learning code, domain-specific task processing guidance, and automated request processing) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as seed messages sets, structured query sets and query record sets to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

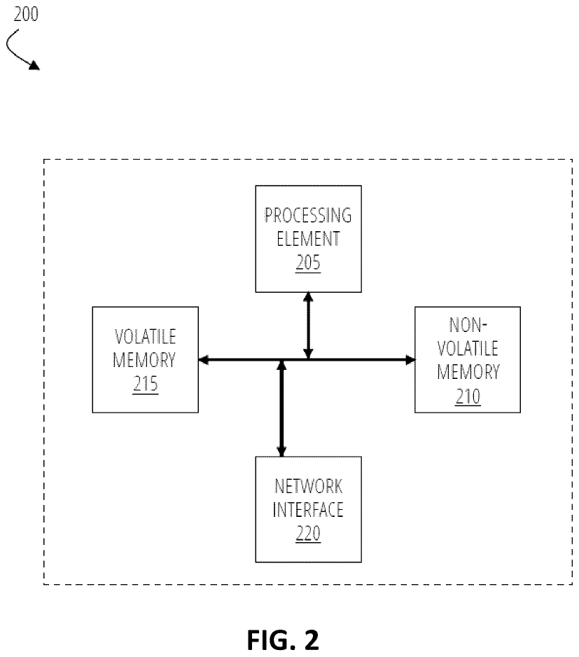

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA20001X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

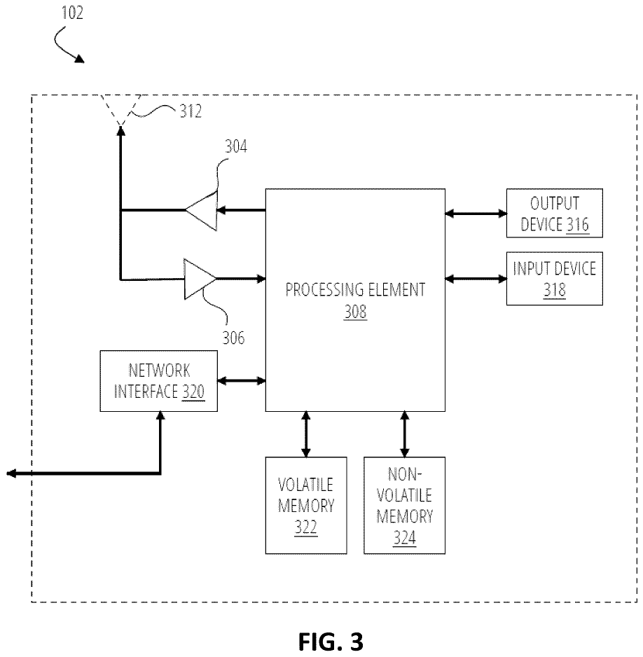

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer interpretation and retrieval techniques and machine learning technologies, such as those used in computer tasks such as automated request processing tasks associated with domain-specific terminologies. In particular, systems and methods are disclosed herein that implement machine learning inference and training techniques to improve computer interpretation of natural language text within a domain, data retrieval, storage, and matching operations in various environments, comprising high-dimensional computing environments. By doing so, the machine learning and training techniques of the present disclosure enable improved computer natural language text interpretation and retrieval process that, when executed on a computer, improves computer performance and computer resource allocation. This, in turn, may improve the functionality of a computer with respect to various computing tasks, comprising machine learning training, data security, network communication, and the like.

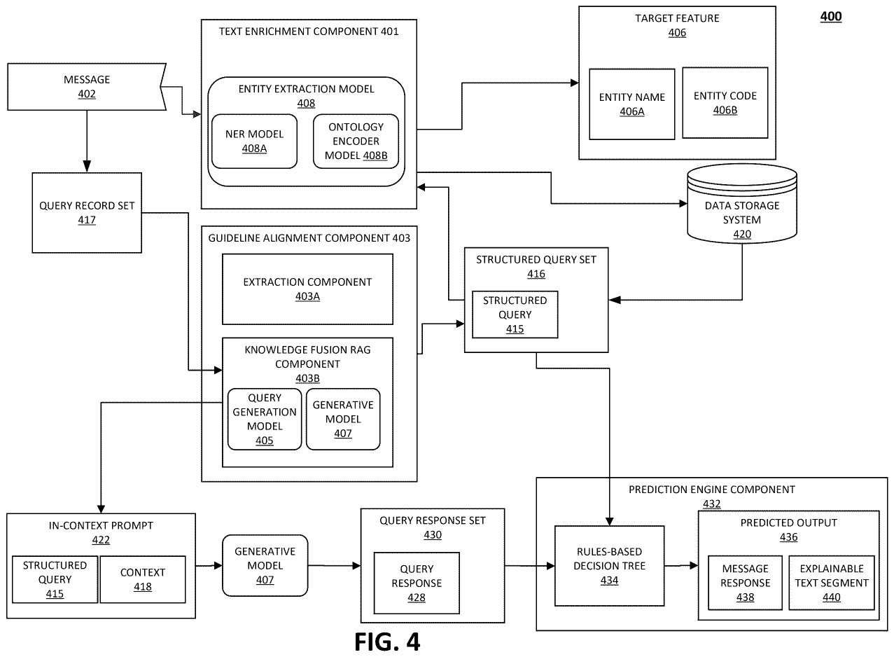

FIG. 4 is a dataflow diagram 400 showing example data structures and components of a machine learning framework for automated request processing task in accordance with some embodiments of the present disclosure. The dataflow diagram 400, for example, illustrates a machine learning framework for receiving a message 402 (or other text, such as detected using optical character recognition (OCR), a speech-to-text model, etc.), autonomously detecting a target feature 406 corresponding to the message 402 based on one or more text units of the message 402, executing a code representation of a structured query set to generate a predicted output 436 for the message 402 that comprises a message response 438 and an explainable text segment 440. As described herein, the predicted output 436 may be generated through an automated machine learning framework that comprises a text enrichment component 401, a guideline alignment component 403, and a prediction engine component 432. The automated machine learning framework employs various techniques comprising, but not limited to, (i) entity extraction techniques that incorporate domain knowledge to facilitate accurate identification, extraction, and matching of disparate domain-specific entities within the prediction domain and identification of the relevant guidelines that guide the machine learning framework, (ii) knowledge fusion RAG techniques that expand relevant task-specific entities in a guideline to facilitate retrieval of relevant information that informs the output of the machine learning framework, and (iii) prediction techniques that enable generation of explanations and justifications for an output of the machine learning framework. In this way, the automated machine learning framework improves the performance of computers, systems, machine learning models, and/or the like associated with automated request processing tasks.

In some embodiments, the computing system 101 receives a message 402. In some embodiments, the computing system 101, using an entity extraction model 408, generates a target feature 406 corresponding to the message 402 based on one or more text units within the message 402. In some embodiments, the target feature is one of a plurality of candidate target features defined by a domain-specific ontology.

In some embodiments, the message 402 is data entity that describes a communication between a sender and a recipient. A message 402 may comprise a textual communication that is provided by a sender to a recipient. By way of example, a message 402 may comprise natural language text, such as an email, a printed text, a handwritten text, a text message, a call transcript, and/or another form of communication from a sender and recipient. A message may be reflective of a task. A message 402 may comprise one or more text units that describes and/or is intended to describe a target entity that is the target of the request processing task. A message 402, for example, may be reflective of a task such as a request that is provided via the message 402. By way of example, with reference to a healthcare domain, the sender may comprise a patient, the message 402 may comprise a medicine refill request message, the one or more text units may comprise a request for a particular medication (e.g., request for renewal of a particular medication), and the target entity may be the particular medication requested.

In some embodiments, the target feature 406 refers to a standardized representation corresponding to one or more similar entities. The one or more similar entities, for example, may have one or more characteristics in common that groups the one or more entities under a particular class corresponding to the target feature, the entities associated with a target feature may be alternate methods of indicating the target feature. For example, the entities associated with a same target feature may comprise different expressions in different programming languages that accomplish a same function, different names for a thing, feature, functionality, etc. (e.g., different brand names for a pharmaceutical, different central processing unit (CPU) names, different CPU names associated with a particular CPU characteristic), etc. A target feature 406 may be domain-specific. For example, a target feature 406 may be defined in a domain-specific ontology. In some embodiments, the target feature 406 comprises a standardized entity name 406A and/or an entity code 406B. As described herein, a target feature 406 may be used in information extraction tasks, where the target feature 406 serves as an anchor for identifying and extracting relevant information from text and/or data storage systems. In healthcare domain context, for example, a target feature 406 may be used to identify relevant guidelines, policies, procedures, and/or other medical text that informs output of a machine learning framework for a medical request processing task.

In some embodiments, domain-specific ontology refers to a data structure that provides a structured representation of entities and features in a particular domain. A domain-specific ontology may capture the entities and relationships that are relevant to the domain, and may provide a common vocabulary for users and systems operating within the domain. In some examples, the domain-specific ontology may be stored in a relational database, with tables for entities and relationships. By way of example, in a healthcare domain context, a domain-specific ontology may comprise medications, diseases, symptoms, procedures, and/or relationships such as causes, treatments, and/or the like. Non-limiting examples of a domain-specific ontology in a healthcare domain context may comprise RxNorm ontology that provides standardized entity names and codes for clinical drugs, CPT ontology that provides a uniform system for identifying medical services and procedures, ICD ontology for coding medical conditions, etc.

In some embodiments, a standardized entity name 406A refers to one or more items of data reflective of a normalized descriptor for a class of one or more similar entities. For example, a standardized entity name 406A may comprise a standardized text-based identifier defined within a domain-specific ontology representative of the one or more similar entities. In a healthcare domain context, for example, a standardized entity name may represent standardized terms for medications, diseases, medications, or procedures, which facilitates interoperability between different systems and databases. A standardized entity name may be defined in the domain-specific ontology along with other relevant information, such as its definition, properties, code, and relationships to other entities.

In some embodiments, an entity code 406B refers to a unique identifier that is associated with a standardized entity name. For example, an entity code 406B may be a unique identifier for a class of one or more similar entities. An entity code may comprise a string of characters, such as a number or a combination of letters and numbers. An entity code 406B may follow a specific coding system or standard. In some examples, an entity code 406B may comprise a machine-readable representation corresponding to a class of one or more similar entities. An entity code 406B may be defined in the domain-specific ontology along with other relevant information, such as name, definition, properties, and relationships to other entity codes. As an example, with reference to a healthcare domain context, an entity code may be used to identify and refer to medications, conditions, procedures, and other relevant entities in a standardized and unambiguous way. Non-limiting examples of an entity code in a healthcare domain context comprise RxNorm code, international classification of diseases (ICD) codes, current procedural terminology (CPT) codes, and/or the like.

In some embodiments, an entity extraction model 408 refers to a data entity that describes parameters, hyper-parameters, and/or defined operations of a machine learning model (e.g., model comprising at least one of one or more rule-based layers, one or more layers that depend on trained parameters, coefficients, and/or the like). An entity extraction model 408 may be configured and/or trained to perform one or more text augmentation operations comprising, but not limited to entity recognition and entity linking. For example, the entity extraction model 408 may be configured and/or trained to perform entity recognition and entity linking functionalities of a text enrichment component 401 as described herein. The entity extraction model 408 may employ advanced natural language processing techniques to analyze and interpret textual data to perform such one or more text augmentation operations. In some embodiments, entity recognition comprises detecting entities in natural language text. In some embodiments, entity linking comprises mapping the detected entities to a target feature 406 corresponding to a class in which they belong as defined in a domain-specific ontology. In some embodiments, the one or more text augmentation operations is designed to enable the entity extraction model 408 to identify a target entity in the message 402 despite misspellings, ambiguity, and/or under-specified tasks in the message 402. Conventional techniques for identifying entities in text data lack such capability.

The entity extraction model 408 may comprise the use of different machine learning architectures, such as graph neural networks for capturing complex relationships between entities, and/or rule-based systems to handle specific edge cases in domain terminology. The entity extraction model 408 may comprise one or more of any type of machine learning model comprising one or more supervised, unsupervised, semi-supervised, and/or reinforcement learning models. In some embodiments, the entity extraction model comprises multiple components that perform the one or more text augmentation operations. In some embodiments, the multiple components comprise two sequential models comprising a named entity recognition (NER) model 408A and an ontology encoder model 408B.

In some embodiments, the computing system 101 retrieve a structured query set 416 associated with the entity code 406B associated with the target feature 406.

In some embodiments, a structured query set 416 comprises and/or is representative of a rules-based logic that guides the output (e.g., a message response 438 described further below) of the machine learning framework, as described herein. The structured query set 416 (e.g., rules-based logic) may comprise one or more structured queries 415 from a guideline specific to the resource processing task. Each structured query 415 may be implemented as a computer-interpretable conditional query that comprise and/or represent a guideline rule from the guideline and a conditional logic (e.g., decision points) for moving to a subsequent conditional query or an end result based on a predicted response (e.g., query response) to the structured query 415. A non-limiting example of such guideline in a healthcare domain context is a clinical guideline that comprises clinical guideline rules relating to a specific entity (e.g., specific RxNorm code) or group of entities.

The structured query set 416 (e.g., rules-based logic) may be implemented as a decision tree 434 that defines a set of connected decision nodes, where each decision node corresponds to and/or comprises a conditional query. The decision nodes may form a tree-like structure that comprise different response pathways (e.g., sequence of decision nodes to different end results/query responses). For example, each response pathway may comprise a sequence of decision nodes to a particular query response, where a query response to a structured query comprises an answer to a guideline rule corresponding to the structured query.

A structured query set 416 may be specific to the prediction domain. Alternatively, or additionally, a structured query set 416 may be specific to the target feature 406 or may be identified based on the target feature 406. For example, the structured query set 416 may be specific to the entity code 406B and/or may be identified based on the entity code 406B. In some embodiments, the computing system 101 retrieves the structured query set 416 from a data storage system 420. For example, the computing system 101 may query the data storage system 420 for a structured query set 416 that is associated with the target feature 406 and, in response, receive the structured query set 416. The data storage system 420, for example, may comprise one or more databases that store one or more structured query sets, where a structured query set is associated with a target feature 406 of one or more target features defined in the domain-specific ontology.

In some embodiments, the computing system 101, using a knowledge fusion RAG framework, generates an in-context prompt 422 for a structured query 415 of the structured query set 416 based on a query record set 417 corresponding to the message 402. For example, the computing system 101 may use a query record set 417 to determine an in-context prompt 422 for a structured query 415 from the structured query set 416. The query response 428 may be one of one or more query responses in a query response set 430 for the structured query set 416. For example, a query response set 430 may comprise the query response (e.g., answer) to each structured query 415 in the structured query set 416. In some embodiments, the computing system 101 may extract at least a portion of the query record set 417 from a data source.

In some embodiments, an in-context prompt 422 comprises instructions provided to a generative model 407, wherein the instructions comprise context 418 that inform the output of the generative model 407. The in-context prompt 422 may comprise the structured query 415 and one or more text segments (e.g., context 418) extracted from the query record set 417 as further described herein.

In some embodiments, a query record set 417 comprises information associated with a user, such as an individual. A query record set 417, for example, may comprise a collection of data records that are relevant to a particular user and may be used to answer queries related to the user. A query record set 417 for a user may be retrieved from one or more record systems. In the context of a healthcare domain, a query record set 417 may comprise electronic health records for a patient and the one or more record systems may comprise electronic health record (EHR) systems. A patient's health records may comprise a wide range of information about the patient's medical history, such as demographic data, vital signs, diagnoses, medications, laboratory test results, imaging studies, and clinical notes from healthcare providers, which may be stored in one or more EHR systems.

In some embodiments, the computing system 101 generates a predicted output 436 for the message 402 that comprises a message response 438 based on the query response 428 (or query response set 430) and an explainable text segment 440 based on a response pathway through the structured query set 416 (e.g., decision tree 434) used in generating the message response 438, as described herein. As further described below, in some embodiments, the computing system 101 may generate the response pathway by executing a computer-executable code corresponding to the decision tree 434, and generate the predicted output based on the response pathway. In some embodiments, the computing system 101 may leverage a generative model and/or other techniques to generate the predicted output 436.

In some embodiments, a response pathway comprises an output (e.g., message response 438) of the machine learning framework and a path through a decision tree 434 to the message response 438. For example, a response pathway may comprise a specific sequence of decision nodes within the decision tree that the computing system 101 followed up till an end result, where the end result is selected by the computing system 101 as the output (e.g., message response)

In some embodiments, a message response 438 refers to a data entity that describes an output of a request processing task executed in accordance with the machine learning framework, described herein. In a healthcare domain context, for example, a message response 438 may comprise a decision to a medicine refill request by a patient. The message response, for example, may indicate whether the refill request is granted or denied.

In some embodiments, an explainable text segment 440 refers to a data entity that summarizes or otherwise describes a path through a decision tree 434 to a message response 438. An explainable text segment 440 may comprise a summary of the response pathway through a decision tree 434 to a message response, providing insight into the machine learning framework described herein for the particular request processing task. An explainable text segment 440 may comprise the decision point(s) encountered and the answer(s) at the decision point(s).

In a healthcare domain context, for example, an explainable text segment 440 may comprise a summary of the response path through the decision tree 434 to a response to a medicine refill request, which response may be a decision to refill or not refill a medication. By way of example, an explainable text segment 440 of a predicted output for a medicine refill request for Levalbuterol may comprise: (1) “First, the system checked if the patient has a chronic condition such as asthma or COPD. The patient records show that the patient has a chronic condition, specifically severe persistent asthma, as mentioned in the disease-related records dated May 10, 2022. Therefore, the answer to Rule 1 is ‘Yes’, and we proceed to Rule 2;” (2) “Next, the system determined if the medication Levalbuterol Inhalant Product (Rxnorm: 1163444) is for asthma or COPD condition. This medication is a short-acting beta-agonist (SABA) and is used as a rescue medication for both asthma and COPD. Thus, the answer to Rule 2 is ‘Yes’, and we proceed to Rule 3;” (3) “Finally, we assessed if Levalbuterol Inhalant Product (Rxnorm: 1163444) is a maintenance medication or a rescue medication for asthma or COPD. This medication is a rescue medication, not a maintenance medication, as it is a short-acting beta-agonist (SABA) used for quick relief of asthma or COPD symptoms. The answer to Rule 3 is ‘No’;” and (4) based on the response path, the medicine refill is authorized as per Rule 3's ‘No’ outcome.” In the above example, “Rxnorm: 1163444” may represent the entity name.

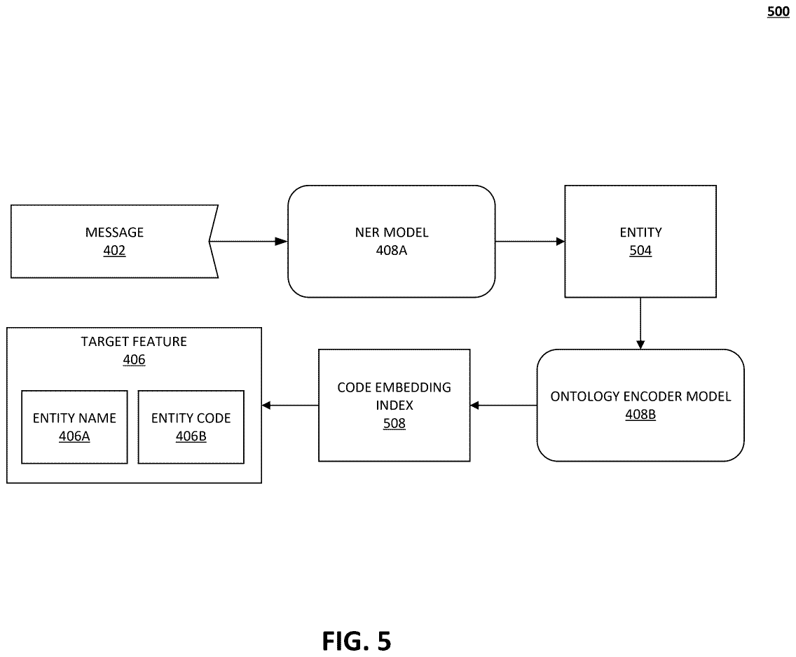

FIG. 5 is an operational example 500 of a machine learning text enrichment pipeline for generating a target feature 406 in accordance with some embodiments of the present disclosure. The text enrichment pipeline may be implemented by the text enrichment component 401 (e.g., using the entity extraction model 408 thereof) of the automated machine learning framework. The machine learning text enrichment pipeline comprises an entity recognition operation configured for detecting an entity 504 for a message 402 using an NER model 408A and entity linking operation configured for mapping the detected entity 504 to the target feature 406 using an ontology encoder model 408B. For example, entity linking may be configured for resolving ambiguities or inconsistencies with respect to the detected entity 504 by mapping the detected entity 504 to the target feature 406. In this way, the machine learning text enrichment pipeline enables precise identification, extraction, and matching of domain entities, thereby enhancing the accuracy of text search, reasoning, and comprehension of the NER model 408A, which in turn improves the accuracy of the output of the machine learning framework.

In some embodiments, the computing system 101, using an NER model 408A, detects an entity 504 for the message 402 based on one or more text units within the message 402. For example, the computing system 101 may provide the message 402 as input to a NER model 408A previously trained to detect an entity 504 for the message 402 based on one or more text units within the message 402. In some embodiments, the NER model 408A comprises a transformer architecture and is previously trained using a synthetic message training dataset as described herein. The synthetic message training dataset may reflect or otherwise comprise domain knowledge not available in conventional training data.

In some embodiments, an entity 504 comprises output of an NER model that describes a named entity mentioned or intended in the message 402. By way of example, in a healthcare domain context, an entity 504 may comprise a medicine name such as, for example, “Breo Ellipta.”

In some embodiments, the computing system 101, using an ontology encoder model 408B, maps the entity 504 to the target feature 406 corresponding to the entity 504. For example, the computing system 101, using the ontology encoder model 408B, may map the entity 504 to the target feature 406 by generating an embedding of the entity 504 and comparing the embedding of the entity to a plurality of embeddings in a code embedding index 508 using a nearest neighbor technique or other approximation techniques. The embedding in the code embedding index 508 that is closest within the embedding space as measured by a distance function, such as a cosine similarity score, Euclidean distance, or Manhattan distance is identified as the target feature 406. The code embedding index 508 may comprise a plurality of embeddings of entity codes defined in the domain-specific ontology and/or plurality of embeddings of entity names defined in the domain-specific ontology. The code embedding index 508 may be pre-generated from other entities within the domain.

In some embodiments, the nearest neighbor technique refers to a local approximation method used in machine learning and data analysis. The nearest neighbor technique may be a non-parametric approach that determines the most relevant pair of data based on the pair's proximity in a feature space. A nearest neighbor technique may involve storing and/or accessing, in memory, a dataset of embeddings associated with input data from which the embeddings were generated, where an embedding is represented as a point in a multi-dimensional feature space. When a new embedding is generated, the nearest neighbor algorithm searches for the k nearest neighbors in the stored dataset, where k is a positive integer. The search process may utilize efficient data structures such as k-d trees or ball trees to reduce computational complexity, especially for high-dimensional datasets.

The nearest neighbor technique, for example, may comprise choosing the nearest neighbor from the k nearest neighbors. In some examples, the nearest neighbor technique may comprise assigning the most common class among the k nearest neighbors to the new data point. In some examples, the nearest neighbor technique may comprise calculating the average or weighted average of the target values of the k nearest neighbors. The choice of distance metric used to measure proximity between data points may significantly impact the algorithm's performance. Example distance metrics comprise Euclidean distance, Manhattan distance, and cosine similarity, among others. A nearest neighbor technique may be implemented using various programming languages and machine learning libraries that provides efficient implementations of k-nearest neighbors algorithms that may handle large datasets and high-dimensional feature spaces. One advantage of the nearest neighbor technique is its simplicity and interpretability, making it useful for exploratory data analysis and as a baseline for more complex models.

In some embodiments, an NER model 408A comprises a machine learning model configured to identify and classify named entities (e.g., entities) within text. The NER model 408A may be implemented using advanced machine learning techniques, such as deep learning architectures. Examples of such deep learning architectures include recurrent neural networks (RNNs), long short-term memory (LSTM) networks, or transformer-based models like BERT (Bidirectional Encoder Representations from Transformers). These models may be trained on large corpus of annotated text data, where entities are manually labeled to provide examples for the model to learn from. The implementation may involve techniques such as word embeddings, contextual embeddings, and/or sequence labeling algorithms to capture the semantic and syntactic information for accurate entity recognition. The NER model may be used in a wide range of applications, including information extraction, question answering systems, content classification, and search engine optimization. For example, in a healthcare context, the NER model may be used to automatically detect patient names, medical conditions, and medication names from natural language text, facilitating efficient data entry and analysis. In some embodiments, the NER model 408A is a transformer-based NER model 408A.

The NER model 408A my employ one or more techniques to analyze and/or process one or more text units within a message 402 reflective of the intended or mentioned entity in the message. In some examples, the message 402 or the one or more text units may comprise misspellings, ambiguity, and/or under-represented tasks. In particular, in some examples, the message 402 may comprise entities not represented in the domain-specific ontology.

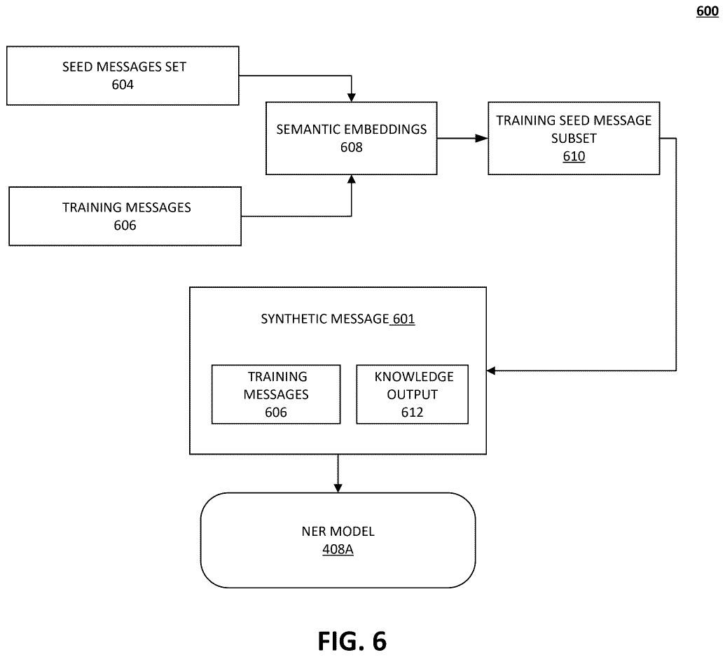

FIG. 6 is an operational example 600 of a framework for generating synthetic message training dataset for training a named entity recognition model in accordance with some embodiments of the present disclosure. As shown in the operational example 600, the NER model 408A is trained on a synthetic message training dataset that incorporates a knowledge output 612 from an generative model based on training messages 606, such that the knowledge output 612 serves as additional input (e.g., auxiliary input) to train the NER model 408A to maximize the probability of accurate label giving the additional input. In this way, training the NER model 408A with such synthetic message training dataset improves the accuracy of text search, reasoning, and comprehension of the NER model 408A, which in turn improves the accuracy of the output of the machine learning framework. A synthetic message training dataset may comprise a plurality of synthetic messages.

In some embodiments, a synthetic message refers to a data entity that describes a model-generated message. For example, a synthetic message may comprise an artificially generated message that mimics real-world message patterns and content and comprises knowledge that is otherwise not in real-world messages. For example, a synthetic message may comprise a training message 606 and a knowledge output 612 based on the training message 606. The knowledge output 612, for example, may correspond to external knowledge such as certain fact and/or information which is generally not in conventional training data and training techniques for training an NER model 408A to adapt to a specific prediction domain task. In this regard, by using synthetic message training dataset, example techniques of the present disclosure address deficiencies in training data and conventional training techniques for training NER models. By employing a training technique for the NER model 408A that uses a synthetic message training dataset, the NER model 408A is exposed to a wider range of examples and addresses data scarcity issues, which improves the accuracy and robustness of the NER model 408A.

In some embodiments, the synthetic message training dataset is generated using a machine learning knowledge generation model that comprises an encoder model and generative model. In some embodiments, the generative model may comprise a large language model (LLM). In some embodiments, the encoder model is trained using a multi-stage training pipeline that comprises domain-specific training stage and a task specific training stage.

In some embodiments, an encoder model refers to a data entity that describes parameters, hyper-parameters, and/or defined operations of a rules-based and/or machine learning model (e.g., model comprising at least one of one or more rule-based layers, one or more layers that depend on trained parameters, coefficients, and/or the like). An encoder extraction model may be configured and/or trained to perform one or more operations associated with text augmentation, such as generating embeddings (e.g., semantic embeddings). These embeddings may be numerical representations of words, phrases, or entire documents that capture their meaning in a high-dimensional vector space, which allows for complex semantic relationships to be represented mathematically, enabling various downstream natural language processing tasks.

An encoder model may be implemented as a computer-based system utilizing machine learning techniques, comprising but not limited to neural networks, deep learning algorithms, or other artificial intelligence approaches. An encoder model may be trained on large datasets of text to learn patterns and representations that capture semantic meaning.

An encoder model may incorporate different architectures depending on the specific requirements of the task. For example, an encoder model may be based on transformer architectures like bidirectional encoder representations (BERT), or utilize other approaches such as recurrent neural networks (RNNs) or convolutional neural networks (CNNs). In some examples, the encoder model comprises a bidirectional long-short term memory (BiLSTM)-conditional random field (CRF) model architecture, such as Vanilla BiLSTM-CRF, which may comprise two bidirectional LSTM layers followed by a CRF layer.

In some embodiments, a domain specific training stage refers to a first training stage for an encoder model. The domain specific training stage may comprise pretraining an encoder model on domain-specific text dataset. In some embodiments, the domain-specific text dataset may comprise a large corpus of data comprising entities specific to the prediction domain. For example, a domain-specific text dataset may comprise a collection of literature, annotations, and/or other data specific to a domain. By way of example, in a healthcare domain context, the domain-specific text dataset may comprise a large biomedical corpus. A domain-specific text dataset may provide a representative sample of the terminology and entities that are relevant to the particular domain.

In some embodiments, pretraining the encoder model on domain-specific text dataset enables understanding of terminology specific to the target domain and/or the unique characteristics and patterns of the target domain, such as the frequent use of abbreviations, acronyms, or specialized terms. The domain specific training stage may comprise generating semantic embeddings based on the domain-specific training dataset. For example, the semantic embedding may comprise word level vector embeddings pretrained on at least a portion of the domain-specific data set. In some embodiments, semantic embeddings refer to vector representations of words that capture semantic relationships. Semantic embeddings may enable models, such as an NER model 408A, to understand real-world data in specific domains. The training process at the domain-specific training stage may comprise iteratively updating the model parameters to reduce a loss determined by a loss function and may employ specific optimization techniques. In some embodiments, a loss optimization algorithm (e.g., gradient descent) is used as the training optimizer to update the model parameters to reduce the loss determined by the loss function. In some embodiments, the loss function is defined as P_real/P_all, which may be designed to maximize the probability of the correct label sequence relative to possible label sequences. By way of example, domain-specific text datasets may be stored in large-scale distributed databases or file systems to enable efficient data retrieval during training.

In some embodiments, the task specific training stage refers to a second training stage for training an encoder model. The task specific training stage may comprise finetuning the pretrained encoder model using task-specific training dataset. Finetuning the encoder model may comprise adjusting the encoder model parameters to better suit the specific task. For example, the task specific training stage may be designed to adapt the pretrained encoder model to the specific task such as, for example, medicine refill request task in a healthcare domain context. Such finetuning may allow the model to adapt to the specific characteristics and requirements of the target task, which improves its performance.

In some embodiments, the task-specific training dataset comprises seed messages set 604 and variational messages to improve the diversity of the task-specific training dataset. In some embodiments, a seed messages set 604 refers to a collection of messages that are used in training a model and/or generating training data for a model. For example, real-world messages in the prediction domain may be assembled and labeled to generate the seed messages set 604. The seed messages set 604 may be carefully assembled and labeled to provide a representative sample of the named entities and their corresponding labels in the target domain. In some embodiments, a seed message of the seed messages set 604 comprises a historical message, a historical message label, and/or a historical message label reasoning. In some embodiments, a historical message is a past real-world message. In a healthcare domain context, for example, a historical message may comprise a past medicine refill request message from a patient. A historical message may comprise one or more text units, such as a sentence or a short paragraph, that contains the target entity intended in the historical message. In some embodiments, a historical message label is a ground truth label assigned to a historical message. A historical message label, for example, may comprise the correct entity for the historical message. The historical message label reasoning may provide an explanation or justification for assigning the historical message label to the historical message. In some examples, about 200 seed messages may be utilized in the task specific training stage.

The seed messages set 604 may be augmented through paraphrasing techniques or other techniques to generate variational messages. In some embodiments, a variational message refers to a variation of a seed message. For example, a variational message may comprise text from a historical message that is paraphrased. Variational messages may help to increase the diversity and robustness of the task-specific training dataset. In some embodiments, one or more models such as a generative model may be used to generate the variational messages. For example, the seed messages set 604 may be input to the generative model to generate and output the variational messages. In some embodiments, the task-specific training dataset is generated based on the seed messages set 604 and variational messages using asymmetric tri-training technique or other technique. An asymmetric tri-training technique may refer to an unsupervised domain adaptation that utilizes three classifiers asymmetrically.

In some embodiments, the synthetic message training dataset is generated by receiving the seed messages set 604; determining, using the machine learning knowledge generation model (e.g., comprising the pretrained encoder model and generative model), a training seed messages subset 610 from the seed messages set 604 based on a training message 606; generating, using the machine learning knowledge generation model, a knowledge output 612; and generating a synthetic message 601 of the synthetic message training dataset by concatenating the training message 606 with the knowledge output 612.

For example, the seed messages set 604 and one or more training messages 606 may be applied to the encoder model (e.g., pretrained and finetuned as described above) to generate semantic embeddings 608 comprising seed message embeddings and training message embeddings. For example, a seed message may be encoded into an embedded representation using the encoder model and a training message may be encoded into an embedded representation of the training message using the encoder model. One or more training seed messages subset 610 from the seed messages set 604 may be identified based on the seed message embeddings and training message embeddings using a nearest neighbor technique and/or other clustering techniques. A training seed messages subset from the one or more training seed messages subset 610 may be associated with a training message of the one or more training messages 606. For example, a training seed messages subset 610 associated with a training message 606 may comprise seed messages from the seed messages set 604 that are semantically similar to the training message 606. In some embodiments, a training message 606 is a real-world message. For example, a training message may comprise a historical message from a seed message of the seed messages set 604.

In some embodiments, a generative knowledge prompt is generated based on the one or more training seed messages subsets and provided to the generative model component of the machine learning knowledge generation model to generate a knowledge output 612 based on the training seed messages subsets. The generative knowledge prompt may comprise the one or more training seed messages subsets 610. For example, the training seed messages subset 610 may be used as prompt examples to instruct the generative model on the type of knowledge to output. For example, the input to the generative model may comprise a training message 606 and a generative knowledge prompt comprising a training seed messages subset 610 generated based on the training message 606. Additionally, the input to the generative model may comprise the seed messages set 604. The generative model may receive the input and generate a knowledge output 612 based on the input. For example, the generative model may generate a knowledge output 612 that captures the patterns from the training seed messages subset 610 and relationship to one or more other entities. In some embodiments, the knowledge output 612 is concatenated or otherwise combined with a training message 606 of a training messages set to generate a synthetic message of the synthetic message training dataset.

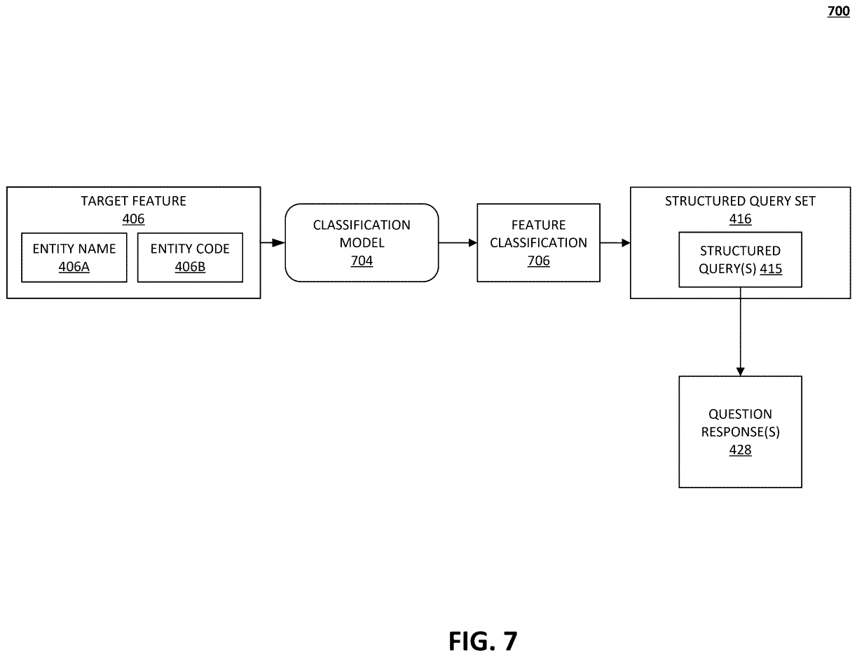

FIG. 7 is an operational example 700 of a machine learning guideline alignment pipeline for generating a query response 428 in accordance with some embodiments of the present disclosure. The machine learning guideline alignment pipeline may be implemented by the guideline alignment component 403 of the machine learning framework, which comprises an extraction component 403A configured for identifying relevant guidelines and a knowledge fusion RAG component 403B configured for aligning, using a knowledge fusion RAG framework, the guidelines with relevant records associated with a user, such as for example, an individual. Such relevant guidelines may be reflective of guidelines that comprise one or more guideline rules that inform the specific request processing task. In this way, the machine learning guideline alignment pipeline enables informed output of the machine learning framework. For example, in a healthcare domain context, the machine learning guideline alignment pipeline may align patient health records with structured guideline rules to facilitate informed patient-centered response to medicine refill requests.

In some embodiments, the computing system 101, using a classification model 704, generates a feature classification 706 based on the entity code 406B such as, for example, RxNorm code. In some examples, generating the feature classification 706 comprises calling in an API associated with the domain-specific ontology with the entity code 406B. By way of example, in a healthcare domain context, the feature classification 706 may comprise a disease class corresponding to the RxNorm code and may provide relevant drug hierarchical information. In some embodiments, a feature classification 706 refers to a data entity that is used to identify relevant guidelines.

In some embodiments, the classification model 704 comprises a machine learning model configured and/or trained to categorize input data into predefined classes or categories. A classification model 704 may be trained on labeled data to learn patterns and relationships that allow it to make predictions for unseen inputs. The classification model 704 may be implemented using one or more machine learning algorithms such as decision trees, support vector machines, neural networks, or ensemble methods such as random forests. The classification model 704 (e.g., the one or more machine learning algorithms thereof) may utilize feature extraction techniques to transform the input data into a suitable representation for classification. The implementation may involve techniques such as one-hot encoding for categorical variables, normalization or standardization of numerical features, and dimensionality reduction methods like Principal Component Analysis (PCA) to improve model performance and efficiency. The classification model 704 may be configured to receive input data comprising an entity name and/or entity code as input and apply the one or more machine learning algorithms thereof to the input data to classify the input data into a category or class (e.g., output a feature classification 706 corresponding to the input data). The classification model may be configured to selection the feature classification 706 from a pre-defined group of feature classifications.

In some embodiments, the computing system 101, receives a structured query set 416 based on the feature classification 706. For example, the computing system 101 may query one or more data sources using the feature classification 706 and receive the structured query set 416 that is associated with the feature classification 706. In some embodiments, the computing system 101 extracts a structured query 415 in the structured query set 416. For example, the computing system 101 may extract each structured query 415 of the one or more structured queries 415 in the structured query set 416.

In some embodiments, the computing system 101, using a generative model and knowledge fusion RAG framework, generates a query response 428 for a structured query 415 of the structured query set 416. For example, the computing system 101, using the generative model and knowledge fusion RAG framework, may generate a query response 428 for each of a plurality of structured queries 415 in the structured query set 416.

In some embodiments, the knowledge fusion RAG framework comprises a technique that enhances the capabilities of generative models by incorporating relevant information retrieved from domain knowledge sources. This approach combines the strengths of information retrieval systems with the generative power of language models to produce more accurate, contextually relevant outputs. The knowledge fusion RAG framework may comprise a knowledge fusion stage for generating an expanded query 809 (described further below) , a query merge and routing stage that merges and routes similar queries for querying against a query record set, a dense retrieval stage for extracting relevant text segments from the query record set using the expanded query 809, a reranking stage for ranking the extracted text segments based on a relevance measure (e.g., embedding similarity measures, such as cosine similarity), and in-context generation stage for generating a query response to a structured query based on the top-ranked text segment for the structured query. In this way, the expanded query captures the core essence of the original structured query and comprises additional information, which enables retrieval of relevant text segments from the query record set to provide more relevant and comprehensive context for a generative model. This in turn reduces or eliminates hallucination and allows for the generative model to generate more accurate query responses.

The dense retrieval stage may be based on dense vector representations and efficient similarity search algorithm for identifying relevant documents or passages from a large corpus of information (e.g., a query record set). The dense retrieval stage may utilize techniques such as approximate nearest neighbor search or semantic indexing to quickly find pertinent information. The retrieved information may then be used to augment the input or context provided to a generative model. The implementation of the knowledge fusion RAG may comprise advanced natural language processing techniques such as cross-attention mechanisms to allow the generative model to selectively focus on the most relevant parts of the retrieved information. It may also involve fine-tuning strategies to adapt pre-trained language models to effectively utilize the retrieved context.

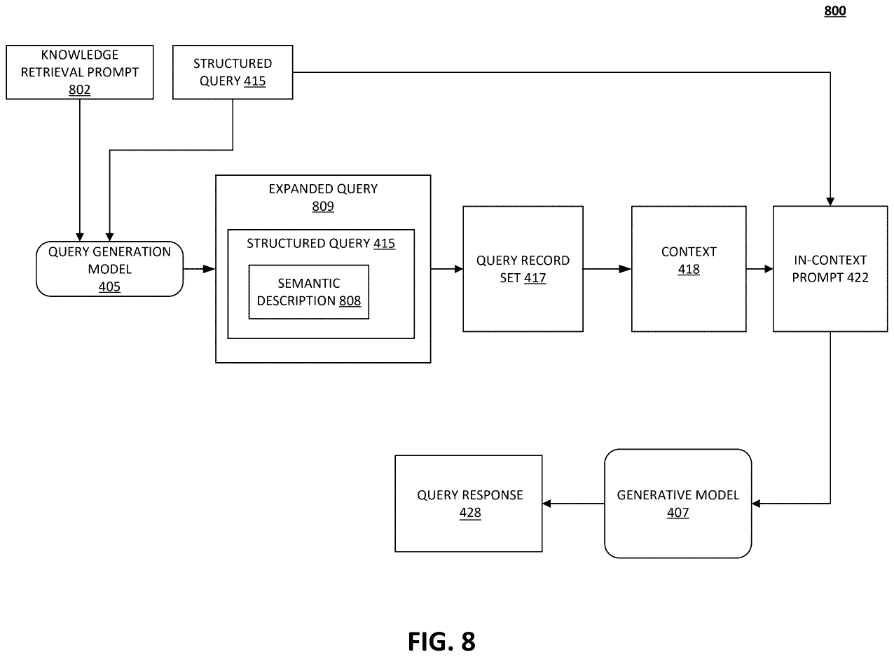

FIG. 8 is an operational example 800 of a knowledge fusion RAG framework in accordance with some embodiments of the present disclosure.

In some embodiments, the computing system 101 generates a knowledge retrieval prompt 802 and provides the knowledge retrieval prompt 802 to a query generation model 405 to generate an expanded query 809. In some embodiments, the query generation model 405 comprises one or more machine learning models configured and/or trained to generate an expanded query from an input query such as a structured query 415. In some embodiments, the query generation model 405 comprises a generation model.

In some embodiments, the knowledge retrieval prompt 802 is a predefined model prompt configured to instruct the query generation model 405 to identify a task-relevant entity in the structured query 415, generate a semantic description 808 for the task-relevant entity in the structured query 415, and generate an expanded query based on the structured query 415 and the semantic description 808.

In some embodiments, a task-relevant entity is a text segment within a structured query 415 reflective of a term and/or the like within the prediction domain that informs a query response 428. A task-relevant entity, for example, may be specific to the prediction domain. By way of example, in a healthcare domain context, guideline suggestions may be obtained from the clinical evidence. For example, certain medicine might cause serious side effects for a patient with high cardiovascular disease risk. Thus, it is important to extract the relevant patient records when making clinical decision. However patient electronic health records, containing a substantial amount of health history, present challenges in identifying single facts due to the amount of irrelevant information. Conventional retrieval techniques and systems struggle to create an effective fully zero-shot system when no relevance label is available. For example, when searching for the relevant text segments from patient health records with the query “Has the patient received a lipid panel in the last 12 months?”, conventional retrieval techniques and systems may not recognize the high relevance between “LDL-Cholesterol” and “lipid panel” without clinical knowledge. As a result, conventional retrieval techniques and systems may provide an incorrect answer when there is no lab result labeled as “lipid panel.”

In this regard, in such healthcare domain context, the knowledge retrieval prompt 802 may comprise “Explain the medical term in the question” “Has the patient received a lipid panel in the last 12 months?” the task-relevant entity may be a medical term, the medical term may be “lipid panel,” and the output of the query generation model 405 may comprise “lipid panel is a blood test that measures the levels for different types of cholesterol and triglycerides.”

The query generation model 405 may employ semantic data modeling to identify and generate the semantic description 808. In some embodiments, semantic data modeling refers to a technique that uses entities and relationships to represent data in a way that is easy to understand and navigate. Semantic data modeling may be particularly useful in domains where data may be complex and multi-dimensional.

In some embodiments, the query generation model 405 may generate the expanded query 809 by fusing the semantic description 808 with the structured query 415. For example, the expanded query 809 may comprise a structured query 415 from a structured query set 416 that is augmented to comprise an explanation or otherwise description of one or more relevant entities in the structured query 415. Continuing with the healthcare domain example above, the semantic description 808 output may be fused with the structured query 415 to generate an expanded query that states: “Has the patient undergone a blood test that measures the level of different types cholesterol and triglycerides, also known as lipid panel, in the last 12 months.” In this regard, the semantic description may facilitate a search and extraction of cholesterol and triglycerides lab results instead of just a search for “lipid.”

In some embodiments, the computing system 101 using the knowledge fusion RAG framework, identifies and merges semantically similar expanded queries and routes the queries for querying against the query record set 417. For example, the RAG framework may comprise a query and routing component that merges and routes semantically similar expanded queries. The computing system 101 using the knowledge fusion RAG framework, may employ one or more techniques to identify semantically similar queries. For example, embeddings of the expanded queries may be generated and compared. The embeddings that are close within the embedding space as measured by a distance function, such as a cosine similarity score may be identified as semantically similar and thus merged and routed.

In some embodiments, the computing system 101 extracts one or more relevant text segments from the query record set based on an expanded query. For example, the computing system 101 may employ a dense retrieval technique. The computing system 101, using an encoder model, may encode the expanded query to generate expanded query embedding and use the expanded query embedding to extract one or more relevant text segments from the query record set. For example, the expanded query embedding may be compared to a plurality of query record text embeddings (e.g., embeddings of text in the query record set). The query record text embeddings that are closest within the embedding space as measured by a distance function, such as a cosine similarity score, are semantically relevant to the query and thus extracted as potentially having an answer to the expanded query. A relevant text segment from a query record set may refer to a query record within the query record set that is relevant for generating a query response to the structured query. The computing system 101 may extract the one or more relevant text segments (e.g., context) using the knowledge fusion RAG framework. In some embodiments, the encoder model leveraged to generate the embeddings may be a pretrained encoder model as described above with reference to FIG. 6.

In some embodiments, the computing system 101, using the RAG framework ranks or re-ranks the text segments in the one or more text segments based on a relevance metric. In some embodiments, a relevance metric is a score, value, and/or the like reflective of the relevance of a text segment to the structured query. For example, a relevance score may be generated for a text segment in the one or more text segments using or more techniques, and the one or more text segments may be ranked based on the relevance score. In some embodiments, the text segment with the higher relevance score is the top-ranked text segment.

In some embodiments, the computing system 101, using a generative model, generates a query response to a structured query 415 based on the structured query 415 and context 418 (e.g., one or more text segments extracted from the query record set 417). For example, the computing system 101, using the knowledge fusion RAG framework may generate an in-context prompt 422 for a structured query 415 that comprises the structured query 415 and context 418 representative of relevant text segment(s) from a query record set 417. For example, the computing system 101 may provide the structured query 415 and context 418 comprising the one or more text segments to a generative model, and receive a query response output by the generative model for the structured query 415 based on the context 418. The one or more text segments may comprise one or more top ranked text segments from the ranked text segments.

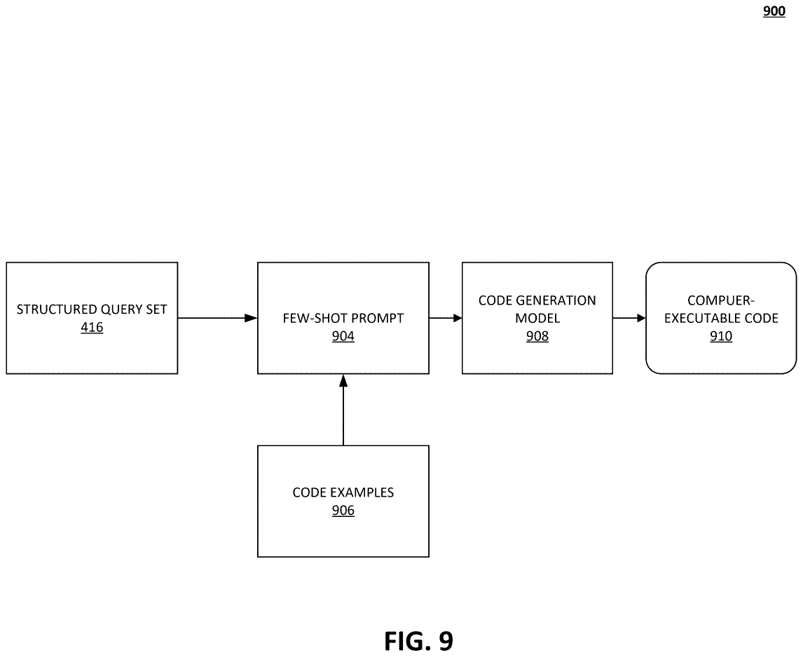

FIG. 9 is an operational example 900 of a code generation pipeline in accordance with some embodiments of the present disclosure. As shown in FIG. 9, the operational example 900 comprises generating a computer-executable code 910 corresponding to a structured query set 416. In this regard, the code generation model obviates the need for a labor-intensive and costly process, such as a manual process, and thus improves efficiency, comprising time and cost savings.

In some embodiments, the computing system 101 generates a few-shot prompt 904 comprising a decision tree and one or more code examples 906 based on the structured query set 416. As described above, a structured query set 416 may be implemented as a decision tree that defines a set of decision nodes respectively corresponding to a structured query in a structured query set. In this regard, the computing system 101 may generate a few shot prompt that comprises a decision tree corresponding to the structured query set 416 and one or more code examples 906.

In some embodiments, a few-shot prompt refers to instructions for a generative model to guide the generative model response to a task and that comprises one or more examples. For example, the few-shot prompt 904 may comprise code examples 906 to guide a code generation model 908 to generate a computer-executable code corresponding to a structured query set 416. In some examples, a code example refers to a past computer-executable code or similar code.

In some embodiments, the code generation model 908 is a generative model configured and/or trained to generate a computer-executable code corresponding to a structured query set 416. For example, the code generation model may be configured to generate computer-executable code corresponding to a decision tree that is representative of the structured query set 416 and which mirrors the logical connections in the decision tree.

In some embodiments, the computing system 101 inputs the few-shot prompt 904 to the code generation model to receive the computer-executable code 910 from the code generation model 908.

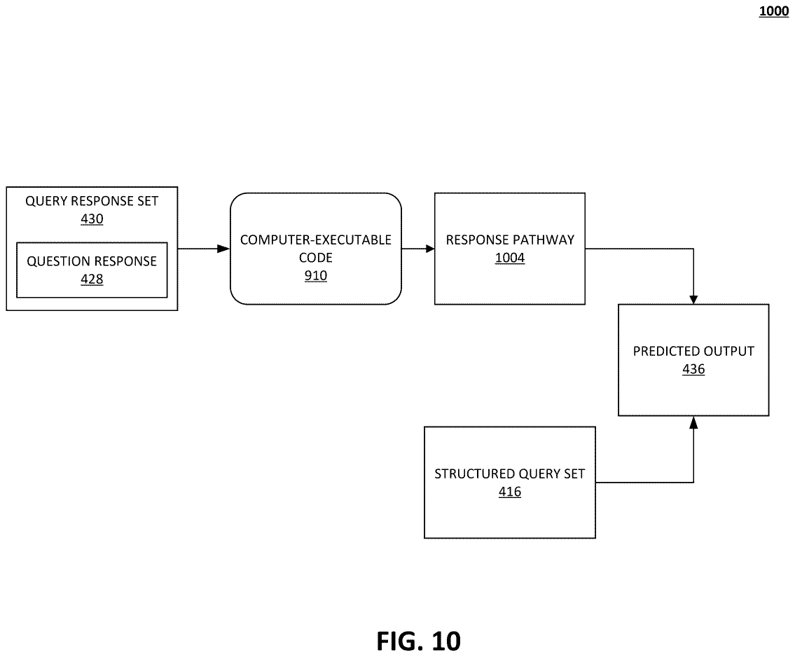

FIG. 10 depicts an operational example 1000 of a prediction pipeline in accordance with some embodiments of the present disclosure. In some embodiments, the prediction pipeline is implemented by the prediction engine component 432 of the machine learning framework, described herein.

In some embodiments, the computing system 101 applies the query response set 430 to a computer-executable code 910 (e.g., representative of a decision tree 434) to receive a response pathway 1004. For example, the computing system 101 may cause execution of the computer-executable code 910 on the query response set 430, wherein the output of the computer-executable code 910 is a response pathway 1004 that comprises a message response 438 and a path through the decision tree 434 to the message response 438.

In some embodiments, the computer-executable code 910 may be one of a plurality of computer-executable codes, where a computer-executable code 910 is associated with a target feature. For example, the computing system 101 may identify the computer-executable code for generating a response pathway 1004 based on the target feature 406 corresponding to the message.

In some embodiments, the computing system 101 generates a predicted output 436 that comprises an explainable text segment 440 and the message response 438 based on the response pathway 1004 and the structured query set 416. For example, the structured query set may serve as a knowledge source for the computing system 101 in generating the explainable text segment 440.

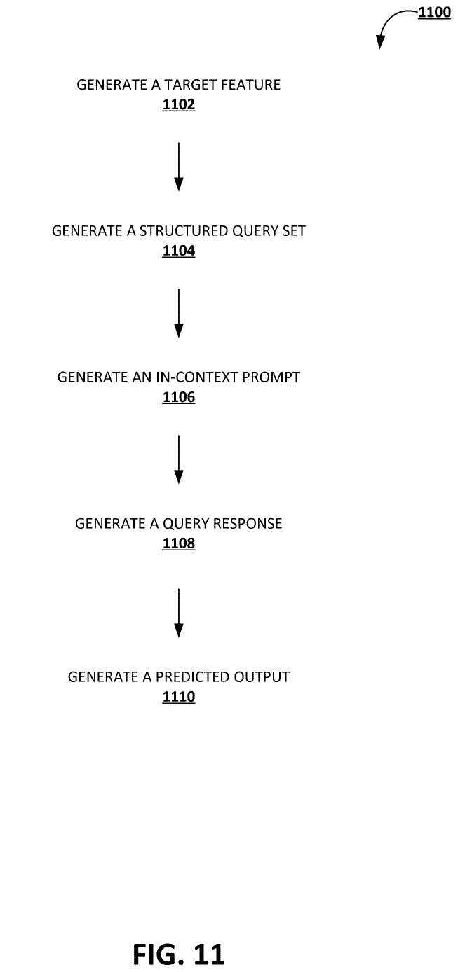

FIG. 11 is a flowchart diagram of an example process 1100 for machine learning framework for request processing tasks in accordance with some embodiments of the present disclosure. The flowchart diagram depicts a multi-stage machine learning model pipeline of the machine learning framework of the present disclosure that adapts text enrichment techniques, knowledge fusion RAG techniques, prediction techniques, knowledge incorporated training techniques, and other techniques of the present disclosure to an automated request processing system to (i) accurately and effectively understand natural language text of a message reflective of a specific request processing task; (ii) resolve discrepancies between entities in natural language text of a message and domain-specific ontology; (iii) enhance the accuracy of text search, reasoning, and comprehension by computers and machine learning models; (iv) enable identification and retrieval of the relevant data that guides and informs the output of the machine learning framework by transforming the natural language text to a recognizable and standardized target feature within the domain; and (v) enable adaptation to dynamic guidelines in a domain by generating and using a computer-executable code to generate predicted output; and (vi) enable generation of a prediction output that comprises an explainable text segment that provides clear explanations of the system's output generation process.

The process 1100 may be implemented by one or more computing devices, entities, and/or systems described herein. For example, via the various steps/operations of the process 1100, the computing system 101 may detect an entity for a message, map the intent classification to a target feature, extract structured query set based on the target features, and implement a knowledge fusion RAG technique, among other techniques described herein. By doing so, the process 1100 improves computer functionality by (i) identifying a wide range of named entities and retrieving relevant query records from available query records, which in turn improves the accuracy of the automated machine learning framework; (ii) enabling improved entity recognition and entity linking, which in turn improves the accuracy of the output of the automated machine learning framework, and (iii) enabling retrieval of relevant text segments from query records to provide more relevant and comprehensive context for a generative model, which in turn reduces or eliminates hallucination and allows for the generative model to generate more accurate query responses.

FIG. 11 illustrates an example process 1100 for explanatory purposes. Although the example process 1100 depicts a particular sequence of steps/operations, the sequence may be altered without departing from the scope of the present disclosure. For example, some of the steps/operations depicted may be performed in parallel or in a different sequence that does not materially impact the function of the process 1100. In other examples, different components of an example device or system that implements the process 1100 may perform functions at substantially the same time or in a specific sequence.

In some embodiments, the process 1100 comprises, at step/operation 1102, generating a target feature. For example, the computing system 101 may generate, using an entity extraction model, a target feature corresponding to a message based on one or more text units within the message. In some embodiments, the target feature is one of a plurality of candidate target features defined by a domain-specific ontology and the entity extraction model comprises (i) a named entity recognition (NER) model that is previously trained to detect an entity based on the one or more text units within the message, and (ii) an ontology encoder that is previously trained, using the domain-specific ontology, to map the intent classification to the target feature. In some examples, the NER model comprises a transformer architecture and is previously trained using a synthetic message training dataset.

In some examples, the synthetic message training dataset is generated by receiving a seed messages set, wherein a seed message of the seed messages set comprises a historical message and a historical message label; determining, using a machine learning knowledge generation model, a training seed messages subset from the seed messages set based on a training message; generating a knowledge output based on the training seed messages subset; and generating a synthetic message of the synthetic message training dataset by concatenating the training message with the knowledge output.

In some embodiments, the process 1100 comprises, at step/operation 1104, generating a structured query set. For example, the computing system 101 may generate a structured query set based on an entity code associated with the target feature. In some examples, the structured query set comprises a decision tree architecture that defines a set of connected query nodes corresponding to the structured query set.

In some embodiments, the process 1100 comprises, at step/operation 1106, generating an in-context prompt. For example, the computing system 101 may generate an in-context prompt for a structured query of the structured query set based on a query record set corresponding to the message. In some examples, the in-context prompt comprises context and the structured query. In some examples, generating the in-context prompt for the structured query of the structured query set comprises inputting a knowledge retrieval prompt to a large language model to receive a semantic description for a task-relevant entity in the structured query, generating, an expanded query by fusing the semantic description with the structured query, extracting a plurality of relevant text segments from the query record set based on the expanded query, ranking the plurality of relevant text segments, and generating the in-context prompt to comprise the structured query and a top-ranked text segment.

In some embodiments, the process 1100 comprises, at step/operation 1108, generating a query response. For example, the computing system 101 may generate, using a RAG framework, a query response for the structured query based on the in-context prompt. In some examples, generating the query response for the structured query based on the in-context prompt comprises applying the context to the structured query.

In some embodiments, the process 1100 comprises, at step/operation 1110, generating predicted output. For example, the computing system 101 may generate, using a generative model, a predicted output for the message that comprises (i) a message response based on the query response and (ii) an explainable text segment based on a response pathway through the structured query set for the message response. In some examples, the response pathway through the structured query set corresponds to a path through the decision tree to the message response. In some examples, generating the predicted, using the generative model, comprises executing a computer-executable code on a query response set comprising the query response to generate the response pathway, and inputting the response pathway to the generative model.

In some examples, the computer-executable code is previously generated by generating a few-shot prompt comprising the decision tree and one or more code examples based on the structured query set, inputting the few-shot prompt to a generative model to receive the computer-executable code, and generating, using a code generation model, the computer-executable code based on the few-shot prompt.

Some techniques of the present disclosure enable the generation of action outputs that may be performed to initiate one or more real world actions to achieve real-world effects. The techniques of the present disclosure may be used, applied, and/or otherwise leveraged to generate alerts, notifications, reply messages, and/or the like. In some examples, the message response output of the present disclosure may trigger action outputs (e.g., through control instructions) to automate downstream processes such as alerts, notifications, reply messages, authorization requests, and/or the like. The action outputs may control various aspects of a client device, such as the display, transmission, and/or the like of data reflective of an alert, and/or the like. The alert may be automatically communicated to a user and/or may be used to initiate an automated screening process, a robotic action (such as, for example, performing an automated medicine refill for a patient, security protocols, and/or the like), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, the operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are elements of a set, but that does not comprise other elements of the set. A first subset of a set may comprise zero, one, or more elements that are also elements of a second subset of the set. The first subset may be said to be a subset of the second subset if the elements of the first subset are elements of the second subset, while also being a subset of the set. However, if the elements of the second subset are also elements of the first subset (in addition to the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured and/or trained to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, the sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, the step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising: generating, by one or more processors and a first machine learning model, a target feature based on a text unit within a message; determining, by the one or more processors, a structured query set based on an entity code associated with the target feature, wherein the structured query set comprises a decision tree that defines a set of connected query nodes corresponding to the entity code; generating, by the one or more processors and using a second machine learning model, a prompt for a structured query of the structured query set based on a query record set that comprises a collection of data records associated with an individual; generating, by the one or more processors and the second machine learning model based on the prompt, a predicted response to the structured query; and generating, by the one or more processors and a third machine learning model based on the predicted response and the structured query set, a predicted output for the message that comprises (i) a message response and (ii) an explainable text segment.

Example 2. The computer-implemented method of example 1, wherein the target feature is one of a plurality of candidate target features defined by a domain-specific ontology and the first machine learning model comprises: (i) a named entity recognition (NER) model that is trained to detect an entity based on the text unit within the message; and (ii) an ontology encoder that is trained, using the domain-specific ontology, to map the entity to the target feature.

Example 3. The computer-implemented method of example 2, wherein the NER model comprises a transformer architecture and is previously trained using a synthetic message training dataset.

Example 4. The computer-implemented method of example 3, wherein the synthetic message training dataset is generated by: receiving a seed messages set, wherein a seed message of the seed messages set comprises a historical message; generating, using a generative model, a knowledge output based on the seed message of the seed messages set; and generating a synthetic message of the synthetic message training dataset by concatenating the knowledge output to the historical message.

Example 5. The computer-implemented method of any of the preceding examples, wherein the prompt comprises the structured query and one or more text segments that are extracted from the query record set based on an embedding similarity between a structured query embedding and a plurality of query record text embeddings of the query record set.

Example 6. The computer-implemented method of example 5, wherein generating the prompt for the structured query of the structured query set comprises: generating, by a generative model based at least in part on a knowledge retrieval prompt, a semantic description for a task-relevant entity extracted from the structured query, wherein the knowledge retrieval prompt comprises a predefined model prompt corresponding to the task-relevant entity; generating an expanded query by fusing the semantic description with the structured query; extracting the one or more text segments from the query record set based on the expanded query; and generating the prompt based on the structured query and the one or more text segments.

Example 7. The computer-implemented method of any of the preceding examples, wherein the explainable text segment comprises a summary of a response pathway through a decision tree corresponding to the structured query set.

Example 8. The computer-implemented method of example 7, wherein generating the predicted output, using the third machine learning model, comprises: executing a computer-executable code on a query response set comprising the predicted response to generate the response pathway; and inputting the response pathway to the third machine learning model.

Example 9. The computer-implemented method of example 8, wherein the computer-executable code is previously generated by: generating a few-shot prompt comprising the decision tree and one or more code examples based on the structured query set; and generating, using a code generation model based on the few-shot prompt, the computer-executable code.

Example 10. A system comprising: one or more processors; and one or more memories storing processor-executable instructions that, when executed by the one or more processors, cause the one or more processors to perform operations comprising: generating, using a first machine learning model, a target feature based on a text unit within a message; determining a structured query set based on an entity code associated with the target feature; generating, using a second machine learning model, a prompt for a structured query of the structured query set based on a query record set comprising a collection of data records; generating, using the second machine learning model and based on the prompt, a predicted response to the structured query; and generating, by the one or more processors and a third machine learning model based on the predicted response and the structured query set, a predicted output for the message that comprises (i) a message response and (ii) an explainable text segment.

Example 11. The system of example 10, wherein the target feature is one of a plurality of candidate target features defined by a domain-specific ontology and the first machine learning model comprises: (i) a named entity recognition (NER) model that is previously trained to detect an entity based on the text unit within the message; and (ii) an ontology encoder that is previously trained, using the domain-specific ontology, to map the entity to the target feature.

Example 12. The system of example 11, wherein the NER model comprises a transformer architecture and is previously trained using a synthetic message training dataset.

Example 13. The system of example 12, wherein the synthetic message training dataset is generated by: receiving a seed messages set, wherein a seed message of the seed messages set comprises a historical message and a historical message label; determining, using a machine learning knowledge generation model, a training seed messages subset from the seed messages set based on a training message; generating a knowledge output based on the training seed messages subset; and generating a synthetic message of the synthetic message training dataset by concatenating the training message with the knowledge output.

Example 14. The system of any of examples 10-13, wherein the prompt comprises context and the structured query, and generating the predicted response for the structured query based on the prompt comprises: applying the context to the structured query.

Example 15. The system of examples 10-14, wherein generating the prompt for the structured query of the structured query set comprises: inputting a knowledge retrieval prompt to a large language model to receive a semantic description for a task-relevant entity in the structured query; generating, an expanded query by fusing the semantic description with the structured query; extracting a plurality of relevant text segments from the query record set based on the expanded query; ranking the plurality of relevant text segments; and generating the prompt to comprise the structured query and a top-ranked text segment.

Example 16. The system of any of examples 10-15, wherein the explainable text segment comprises a summary of a response pathway through a decision tree corresponding to the structured query set.

Example 17. The system of example 16, wherein generating the predicted output, using the third machine learning model, comprises: executing a computer-executable code on a query response set comprising the predicted response to generate the response pathway; and inputting the response pathway to the third machine learning model.

Example 18. The system of example 17, wherein the computer-executable code is previously generated by: generating a few-shot prompt comprising the decision tree and one or more code examples based on the structured query set; inputting the few-shot prompt to a generative model to receive the computer-executable code; and generating, using a code generation model, the computer-executable code based on the few-shot prompt.

Example 19. One or more non-transitory computer-readable media storing processor-executable instructions that, when executed by one or more processors, cause the one or more processors to perform operations comprising: generating, using a first machine learning model, a target feature based on a text unit within a message; determining a structured query set based on an entity code associated with the target feature; generating, using a second machine learning model, a prompt for a structured query of the structured query set based on a query record set comprising a collection of data records; generating, using the second machine learning model and based on the prompt, a predicted response to the structured query; and generating, by the one or more processors and a third machine learning model based on the predicted response and the structured query set, a predicted output for the message that comprises (i) a message response and (ii) an explainable text segment.

Example 20. The one or more non-transitory computer-readable media of example 19, wherein the target feature is one of a plurality of candidate target features defined by a domain-specific ontology and the first machine learning model comprises: (i) a named entity recognition (NER) model that is previously trained to detect an entity based on the text unit within the message; and (ii) an ontology encoder that is previously trained, using the domain-specific ontology, to map the entity to the target feature.

Example 21. The computer-implemented method of example 1, wherein the method further comprises training the first machine learning model, second machine learning model, and third machine learning model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 10, wherein the one or more processors are further configured to train the first machine learning model, second machine learning model, and third machine learning model.

Example 25. The computing system of example 24, wherein the one or more processors are comprised in a first computing entity; and the first machine learning model, second machine learning model, and third machine learning model is trained by one or more other processors comprised in a second computing entity.

Example 26. The one or more non-transitory computer-readable storage media of example 19, wherein the instructions further cause the one or more processors to train the first machine learning model, second machine learning model, and third machine learning model.

Example 27. The one or more non-transitory computer-readable storage media of example 26, wherein the one or more processors are comprised in a first computing entity; and the first machine learning model, second machine learning model, and third machine learning model is trained by one or more other processors comprised in a second computing entity.

1. A computer-implemented method comprising:
generating, by one or more processors and a first machine learning model, a target feature based on a text unit within a message;
determining, by the one or more processors, a structured query set based on an entity code associated with the target feature, wherein the structured query set comprises a decision tree that defines a set of connected query nodes corresponding to the entity code;
generating, by the one or more processors and using a second machine learning model, a prompt for a structured query of the structured query set based on a query record set that comprises a collection of data records associated with an individual;
generating, by the one or more processors and the second machine learning model based on the prompt, a predicted response to the structured query; and
generating, by the one or more processors and a third machine learning model based on the predicted response and the structured query set, a predicted output for the message that comprises (i) a message response and (ii) an explainable text segment.

2. The computer-implemented method of claim 1, wherein the target feature is one of a plurality of candidate target features defined by a domain-specific ontology and the first machine learning model comprises:
(i) a named entity recognition (NER) model that is trained to detect an entity based on the text unit within the message; and
(ii) an ontology encoder that is trained, using the domain-specific ontology, to map the entity to the target feature.

3. The computer-implemented method of claim 2, wherein the NER model comprises a transformer architecture and is previously trained using a synthetic message training dataset.

4. The computer-implemented method of claim 3, wherein the synthetic message training dataset is generated by:
receiving a seed messages set, wherein a seed message of the seed messages set comprises a historical message;
generating, using a generative model, a knowledge output based on the seed message of the seed messages set; and
generating a synthetic message of the synthetic message training dataset by concatenating the knowledge output to the historical message.

5. The computer-implemented method of claim 1, wherein the prompt comprises the structured query and one or more text segments that are extracted from the query record set based on an embedding similarity between a structured query embedding and a plurality of query record text embeddings of the query record set.

6. The computer-implemented method of claim 5, wherein generating the prompt for the structured query of the structured query set comprises:
generating, by a generative model based at least in part on a knowledge retrieval prompt, a semantic description for a task-relevant entity extracted from the structured query, wherein the knowledge retrieval prompt comprises a predefined model prompt corresponding to the task-relevant entity;
generating an expanded query by fusing the semantic description with the structured query;
extracting the one or more text segments from the query record set based on the expanded query; and
generating the prompt based on the structured query and the one or more text segments.

7. The computer-implemented method of claim 1, wherein the explainable text segment comprises a summary of a response pathway through a decision tree corresponding to the structured query set.

8. The computer-implemented method of claim 7, wherein generating the predicted output, using the third machine learning model, comprises:
executing a computer-executable code on a query response set comprising the predicted response to generate the response pathway; and
inputting the response pathway to the third machine learning model.

9. The computer-implemented method of claim 8, wherein the computer-executable code is previously generated by:
generating a few-shot prompt comprising the decision tree and one or more code examples based on the structured query set; and
generating, using a code generation model based on the few-shot prompt, the computer-executable code.

10. A system comprising:
one or more processors; and
one or more memories storing processor-executable instructions that, when executed by the one or more processors, cause the one or more processors to perform operations comprising:
generating, using a first machine learning model, a target feature based on a text unit within a message;
determining a structured query set based on an entity code associated with the target feature;
generating, using a second machine learning model, a prompt for a structured query of the structured query set based on a query record set comprising a collection of data records;
generating, using the second machine learning model and based on the prompt, a predicted response to the structured query; and
generating, by the one or more processors and a third machine learning model based on the predicted response and the structured query set, a predicted output for the message that comprises (i) a message response and (ii) an explainable text segment.

11. The system of claim 10, wherein the target feature is one of a plurality of candidate target features defined by a domain-specific ontology and the first machine learning model comprises:
(i) a named entity recognition (NER) model that is previously trained to detect an entity based on the text unit within the message; and
(ii) an ontology encoder that is previously trained, using the domain-specific ontology, to map the entity to the target feature.

12. The system of claim 11, wherein the NER model comprises a transformer architecture and is previously trained using a synthetic message training dataset.

13. The system of claim 12, wherein the synthetic message training dataset is generated by:
receiving a seed messages set, wherein a seed message of the seed messages set comprises a historical message and a historical message label;
determining, using a machine learning knowledge generation model, a training seed messages subset from the seed messages set based on a training message;
generating a knowledge output based on the training seed messages subset; and
generating a synthetic message of the synthetic message training dataset by concatenating the training message with the knowledge output.

14. The system of claim 10, wherein the prompt comprises context and the structured query, and generating the predicted response for the structured query based on the prompt comprises:
applying the context to the structured query.

15. The system of claim 10, wherein generating the prompt for the structured query of the structured query set comprises:
inputting a knowledge retrieval prompt to a large language model to receive a semantic description for a task-relevant entity in the structured query;
generating, an expanded query by fusing the semantic description with the structured query;
extracting a plurality of relevant text segments from the query record set based on the expanded query;
ranking the plurality of relevant text segments; and
generating the prompt to comprise the structured query and a top-ranked text segment.

16. The system of claim 10, wherein the explainable text segment comprises a summary of a response pathway through a decision tree corresponding to the structured query set.

17. The system of claim 16, wherein generating the predicted output, using the third machine learning model, comprises:
executing a computer-executable code on a query response set comprising the predicted response to generate the response pathway; and
inputting the response pathway to the third machine learning model.

18. The system of claim 17, wherein the computer-executable code is previously generated by:
generating a few-shot prompt comprising the decision tree and one or more code examples based on the structured query set;
inputting the few-shot prompt to a generative model to receive the computer-executable code; and
generating, using a code generation model, the computer-executable code based on the few-shot prompt.

19. One or more non-transitory computer-readable media storing processor-executable instructions that, when executed by one or more processors, cause the one or more processors to perform operations comprising:
generating, using a first machine learning model, a target feature based on a text unit within a message;
determining a structured query set based on an entity code associated with the target feature;
generating, using a second machine learning model, a prompt for a structured query of the structured query set based on a query record set comprising a collection of data records;
generating, using the second machine learning model and based on the prompt, a predicted response to the structured query; and
generating, by the one or more processors and a third machine learning model based on the predicted response and the structured query set, a predicted output for the message that comprises (i) a message response and (ii) an explainable text segment.

20. The one or more non-transitory computer-readable media of claim 19, wherein the target feature is one of a plurality of candidate target features defined by a domain-specific ontology and the first machine learning model comprises:
(i) a named entity recognition (NER) model that is previously trained to detect an entity based on the text unit within the message; and
(ii) an ontology encoder that is previously trained, using the domain-specific ontology, to map the entity to the target feature.
